(19) United States
(12) Patent Application Publication
(10) Pub. No.: US 2003/0140150 A1
(43) Pub. Date: Jul. 24, 2003

(54) Self-monitoring service system with reporting of asset changes by time and category

(76) Inventors: Dean Kemp, Superior, CO (US); Dario Atallah, Louisville, CO (US); Clement Ng, Toronto (CA); Hong Yu, Markham (CA)

Correspondence Address: HOGAN & HARTSON LLP, ONE TABOR CENTER, SUITE 1500, 1200 SEVENTEEN ST., DENVER, CO, 80202, US

(21) Appl. No.: 10/179,111

(22) Filed: Jun. 25, 2002

Related U.S. Application Data
(60) Provisional application No. 60/348,650, filed on Jan. 14, 2002.
(60) Provisional application No. 60/377,088, filed on Apr. 30, 2002.

(51) Int. Cl. G06F 15/173; G06F 15/16

(52) U.S. Cl. 709/229

(57) ABSTRACT

A method for reporting computer system and network asset changes. The method includes receiving from a client node first and second comparison points, such as survey dates or user-entered dates. The method continues with retrieving from memory sets of asset data corresponding to each of the comparison points and then comparing the sets of asset data to identify asset deltas. An asset delta report is transmitted to the client node providing the sets of asset data for the two comparison points and change of status flags or other indications of which assets were determined to have changes at the two comparison points. Viewing parameters and filtering variables, such as particular monitored systems and asset subsets, are received and used to determine which asset data sets to compare and to include in the asset delta report. To reduce storage requirements, asset data is stored when changes occur between asset surveys.

### CROSS-REFERENCE TO RELATED APPLICATIONS

This application claims the benefit of U.S. Provisional Application No. 60/348,650, filed Jan. 14, 2002, and U.S. Provisional Application No. 60/377,088, filed Apr. 30, 2002, the disclosures of which are herein specifically incorporated in its entirety by this reference.

### BACKGROUND OF THE INVENTION

1. Field of the Invention

The present invention relates, in general, to monitoring, reporting, and asset tracking software and systems, and more particularly, to a method and system for determining changes in system assets over time based on data asset surveys for monitored systems and for reporting such asset deltas or changes based on user-selectable data collection dates, asset categories, and other parameters.

2. Relevant Background

The need for effective and cost efficient monitoring and control of computer systems, i.e., systems management, continues to grow at a rapid pace in all areas of commerce. An ongoing difficulty with managing computer systems is tracking changes in the system components and their configurations, which is sometimes labeled system assets. to improve customer service and staff and customer productivity, reducing computer and network costs, and reducing operating expenditures (including reducing support and maintenance staff needs). A recent computer industry study found that the average cost per hour of system downtime for companies was $90,000 with each company experiencing 9 or more hours of mission-critical system downtime per year. For these and other reasons, the market for system monitoring and management tools has increased dramatically and with this increased demand has come pressure for more effective and user-friendly tools and features.

Several system asset management tools have been developed but have not been completely effective in meeting the demands for efficient and useful diagnostics, system monitoring, and asset planning tools. Asset survey tools have been developed that capture, store, and report data pertaining to the system assets, including information on system CPUs (central processing units), hard disks, file systems, installed packages and patches, network interfaces, and other hardware and software information. Unfortunately, existing asset survey tools have not proven particularly useful in debugging a system or performing system diagnostics because the information available is typically a snapshot of the system assets as of the data and time the asset survey tool was run but fails to provide any information on asset changes.

Asset change information or delta information is very important to debuggers and system managers. For diagnostics, the asset change information allows a debugger to identify potential changes to an asset that may have triggered an operating problem. For example, if a system or a component begins to have operating problems, a debugger can try to identify the last date when the system or component was operating satisfactorily and then determine what changes have been made to the system or component. For system managers, asset change information is useful for tracking changes to a system over time which may be useful for personnel and facilities planning efforts (such as identifying the need for larger system capacity at certain times of the year and other cyclical operating patterns). Asset change information also enables system managers to track progress of work efforts and maintenance on their systems, such as by allowing them to determine if system hardware and/or operating system parameters (such as patches) have been changed out or added.

Presently, asset change information is typically manually gathered in a time-consuming and costly process. The process may involve the manual comparison of all or portions of the information in a historic, printed asset survey report with a more recently printed asset survey report. Some asset survey tools operate to periodically collect and store asset survey data and allow a report to be generated for two selected dates or in some cases, save only changes made to the system. These tools, though, require a large amount of memory to store the historic survey information. Further, an operator still has to identify asset changes by comparing historic with present asset survey data (or by comparing data at or two historic data points). Existing asset survey tools are not user-friendly and do not facilitate the quick identification of asset changes in monitored system or systems.

Hence, there remains a need for an improved system and method for monitoring computer systems that addresses the need for identifying and reporting system asset change information. Preferably, such a system and method would identify and report changes or deltas in a monitored system or portions of a monitored system in a user-friendly fashion and allow a user to input comparison dates for determining asset changes and in some cases, allow a user to select particular assets and/or portions of an overall monitored network or system for performing asset comparisons.

### SUMMARY OF THE INVENTION

To address the above and other deficiencies with existing monitoring systems, a self-monitoring system is provided that includes data providers at each monitored system within a client environment to collect asset information and includes an asset survey mechanism at a remote but linked service provider system to identify asset changes in the collected asset information, to store asset information and asset changes, and to report asset changes or deltas to client monitoring personnel. The reporting feature of the system allows a complete inventory of monitored systems to be displayed and, significantly, allows the monitoring personnel or client users to view asset changes, such as patch changes, on a particular system or domain between two comparison points or asset surveys. In some embodiments, client users can filter what portions of the overall client environment or monitored systems are viewed using comparison parameters such as by selecting a particular system or a network and/or particular components within such selected system, e.g., CPUs, server models, systems with certain operating systems, and the like. The comparison points may be dates entered by the client users or asset surveys selected from a displayed listing of surveys. In this fashion, the self-monitoring system of the present invention functions to enable a client user to efficiently and effectively determine asset changes to their monitored systems or selected system portions.

More particularly, the invention provides a computerized method for tracking and reporting changes or deltas to assets (e.g., hardware and software components and the like) within a client's computer system and network environment. The method includes establishing a communications link via a data communications network with a client node having a graphical user interface and/or browsers and then receiving from the client node first and second comparison points, such as selectable survey dates or user-selected dates and/or times. The method continues with retrieving from memory sets of asset data corresponding to each of the comparison points and then comparing the sets of asset data to identify asset deltas. An asset delta report is transmitted to the client node providing the sets of asset data for the two comparison points and change of status flags or other indications of which assets were determined to have changes at the two comparison points.

In one embodiment, the method includes comparing asset data at the earlier comparison point with asset data at intermediary times between the two comparison points to identify intermediary changes that occurred to the assets and then including an intermediary change flag or warning for each such asset or asset subcomponent. An operator of the client node can then request, such as by selecting the change flag, additional information on the intermediary change. The method also may include displaying viewing or reporting parameters and filter variables which the user of the client node can then select to control the comparing and reporting processes. For example, the viewing parameters may include which monitored systems within the overall client environment are to be compared for the asset delta report to allow a client to quickly inspect assets and asset changes in, in some cases, particular systems. The filter variables include assets and subsets for a particular asset. For example, a user of the client node may select and/or enter filter variables to request comparisons on only a subset of the assets of each selected system and then for particular assets, such as operating systems, request that selected assets only be compared if the asset has a selected value, i.e., is within the asset subset. These features of the tracking and reporting method allow users to control at which points in time comparisons are made, which of their systems are compared, and which assets are compared and included in asset delta reports.

### BRIEF DESCRIPTION OF THE DRAWINGS

FIG. 1 illustrates a self-monitoring service system with asset survey delta reporting according to the present invention generally showing a service provider system and its services linked by networks and relays to a large number of monitored systems;

FIG. 2 illustrates one embodiment of a service system of FIG. 1 showing data collectors or providers within the monitored system for gathering asset data and asset survey devices and databases within the service provider system that function to selectively store and report asset survey data to quickly provide asset changes in the monitored system;

FIG. 3 is a flow chart illustrating an exemplary asset survey process including determining and storing asset changes and reporting such changes based on user-selectable comparison points (e.g., times and/or dates) and reporting parameters;

FIG. 4 is a screenshot of a user interface screen used by the asset survey mechanism in obtaining a user's input for comparison dates and reporting parameters, such as which portion of a monitored system or systems to compare and which component's within such selected system to compare for changes and updates; and

FIG. 5 is another screenshot illustrating an asset survey system profile delta report that is provided for a user-selected filtering, e.g., all asset information compared for a selected system.

### DETAILED DESCRIPTION OF THE PREFERRED EMBODIMENTS

The present invention is directed to a method and system of providing self-monitoring services to clients to allow monitoring of asset changes for their computer systems and networks. More specifically, a service system is provided that includes data collection devices within the client system to periodically collect or survey asset information and to pass this information to a service provider system for processing and storage. In the following description the system utilizes specifically configured forwarding or fan-out relays within the customer system to provide a cascaded pipeline that controls the transmission of data and/or messages between a monitored relay or system and a service provider system and allows the customer system to be readily scaled up and down in size to include hundreds or thousands of monitored systems and nodes. However, other network and data transmission configurations and/or techniques may be used to practice the invention.

At the service provider system, an asset survey mechanism processes sequential surveys to identify asset changes and to store the original asset information and asset changes (not the entire results of every survey). The asset survey mechanism then functions to communicate with a user or monitor of the client environment (such as with graphical user interface and an asset survey report screen(s) displayed on a web browser) to receive comparison points and other reporting or filtering parameters. Asset changes for the inputted comparison points and filtering parameters are determined and then reported to the user.

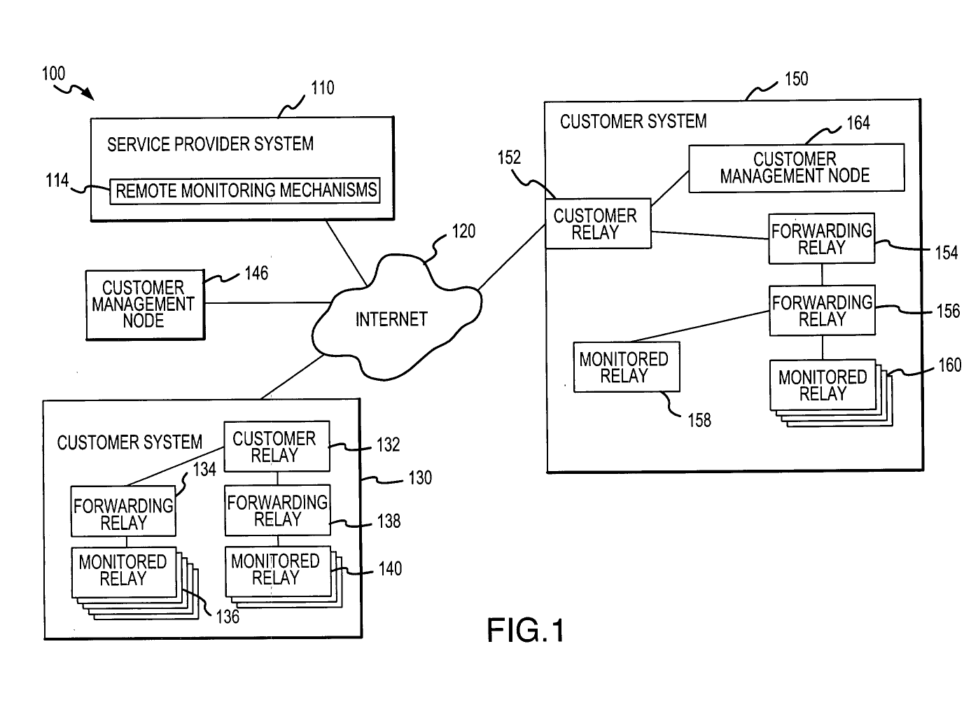

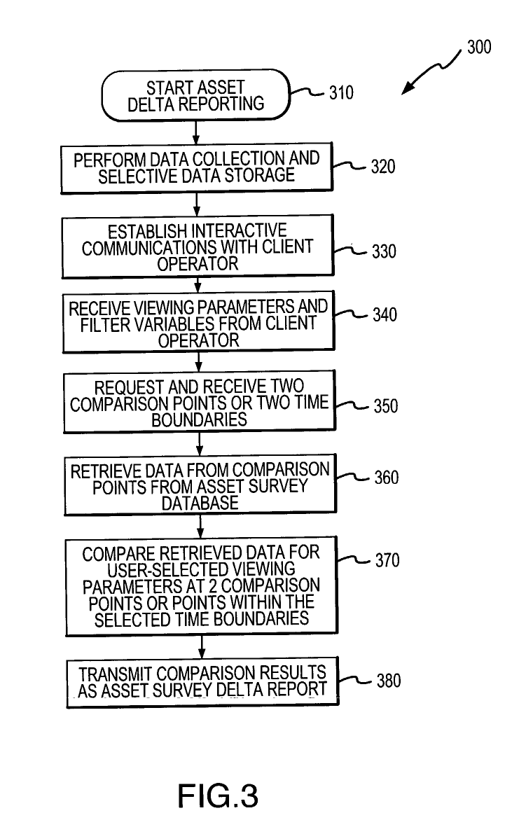

With this brief overview in mind, the following description begins with a description of a typical service system of the invention with reference to FIG. 1 and continues with a more specific description of the various components included within a service provider system, a forwarding relay, and a monitored system to provide the desired functions of the invention. The asset survey change determination, storage, and reporting functions are then described fully with reference to FIGS. 3-5.

Referring to FIG. 1, a self-monitoring service system 100 is shown that according to the invention provides improved tracking and reporting of asset changes within monitored systems. The system 100 includes a service provider system 110 with remote monitoring mechanisms 114 that function to process collected data and provide event, alert, trending, status, and other relevant monitoring data and asset survey delta information in a useable form to monitoring personnel, such as via customer management nodes 146, 164. The service provider system 110 is linked to customer systems or sites 130, 150 by the Internet 120 (or any useful combination of wired or wireless digital data communication networks). The communication protocols utilized in the system 100 may vary to practice the invention and may include for example TCP/IP and SNMP. The service provider system 110 and customer systems 130, 150 (including the relays) may comprise any well-known computer and networking devices such as servers, data storage devices, routers, hubs, switches, and the like. The described features of the invention are not limited to a particular hardware configuration or to particular hardware and software components.

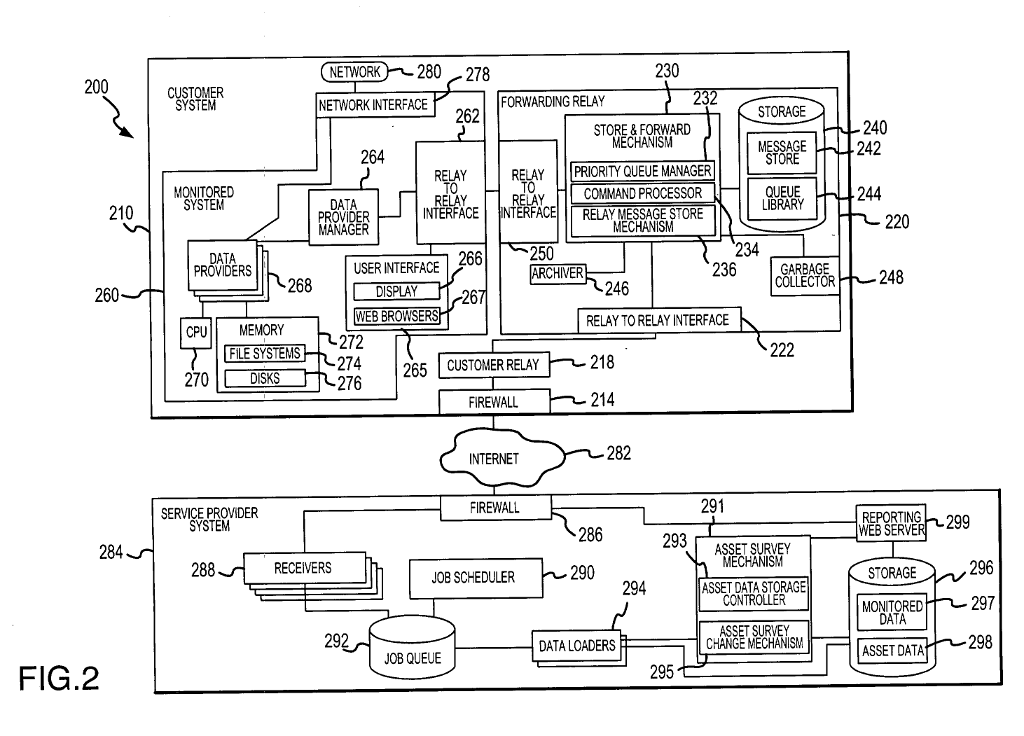

The service system 100 is adapted to control data transmissions, including asset survey collected data and asset survey delta reports, within the customer systems 130, 150 and between the service provider system 110 and the customer systems 130, 150. In this regard, the system 100 includes a cascaded pipeline architecture that includes within the customer systems 130, 150 linked customer or Internet relays 132, 152, forwarding (or intermediate or fan-out) relays 134, 138, 154, 156, and monitored relays 136, 140, 158, 160. The monitored relays 136, 140, 158, 160 are end nodes or systems being monitored in the system 100 (e.g., at which configuration, operating, status, and other data is collected). The forwarding relays 134, 138, 154, 156 are linked to the monitored relays 136, 140, 158, 160 and configured to support (or fan-out) monitored systems to forwarding relay ratios of 500 to 1 or larger. The configuration and operation of the forwarding relays 134, 138, 154, 156 are described in detail with reference to FIGS. 2-4. In one embodiment, the pipeline is adapted to control the transmission of data or messages within the system, and the forwarding relays act to store and forward received messages (from upstream and downstream portions of the pipeline) based on priorities assigned to the messages. The customer relays 132, 152 are positioned between the Internet 120 and the forwarding relays 134, 138, 154, 156 and function as an interface between the customer system 130, 150 (and, in some cases, a customer firewall) and the Internet 120 and control communication with the service provider system 110.

The system 100 of FIG. 1 illustrates that multiple forwarding relays 134, 138 may be connected to a single customer relay 132 and that a single forwarding relay 134 can support a large number of monitored relays 136 (i.e., a large monitored system to forwarding relay ratio). Additionally, forwarding relays 154, 156 may be linked to provide more complex configurations and allow more monitored systems to be supported within a customer system 130, 150. Customer management nodes 146, 164 used for displaying and, thus, monitoring collected and processed system data, such as asset survey delta input web pages and asset survey delta reports, may be located anywhere within the system 100 such as within a customer system 150 as node 164 is or directly linked to the Internet 120 and located at a remote location as is node 146. In a typical system 100, more customer systems 130, 150 would be supported by a single service provider system 110 and within each customer system 130, 150 many more monitored relays or systems and forwarding relays would be provided, with FIG. 1 being simplified for clarity and brevity of description.

FIG. 2 shows a monitoring service system 200 that includes a single customer system 210 linked to a service provider system 284 via the Internet 282. FIG. 2 is useful for showing more of the components within the monitored system or relay 260, the forwarding relay 220, and the service provider system 284 that function separately and in combination to facilitate collection and transmittal of asset survey data and to process and report asset survey changes based on user input reporting or filtering parameters.

As shown, the customer system 210 includes a firewall 214 connected to the Internet 282 and a customer relay 218 providing an interface to the firewall 214 and controlling communications with the service provider system 284. The customer system 210 includes a forwarding relay 220 linked to the customer relay 218 and a monitored system 260. The forwarding relay 220 functions, in part, to provide an effective useful communication link between the monitored system 260 and the service provider system 284 and accepts data from upstream and downstream sources and reliably and securely delivers it to the recipient. Throughout the following discussion, the monitored system 260 will be considered the most upstream point and the service provider system 284 the most downstream point with data (i.e., “messages”) flowing downstream from the monitored system 260 to the service provider system 284.

The forwarding relay 220 accepts data from upstream and downstream sources and reliably and securely delivers it downstream and upstream, respectively. The relay 220 caches file images and supports a recipient list model for upstream (fan-out) propagation of such files. The relay 220 manages the registration of new monitored systems and manages retransmission of data to those new systems. In some embodiments, the forwarding relay 220 implements a priority scheme to facilitate efficient flow of data within the system 200. The forwarding relay 220 includes two relay-to-relay interfaces 222, 250 for receiving and transmitting messages to connected relays 218, 260. A store and forward mechanism 230 is included for processing messages received from upstream and downstream relays and for building and transmitting messages. This may be thought of as a store and forward function that is preferably provided within each relay of the system 200 (and system 100 of FIG. 1) and in some embodiments, such message building and transmittal is priority based. To provide this functionality, the store and forward mechanism 230 includes a priority queue manager 232, a command processor 234, and a relay message store mechanism 236 and is linked to storage 240 including a message store 242 and a priority queue library 244.

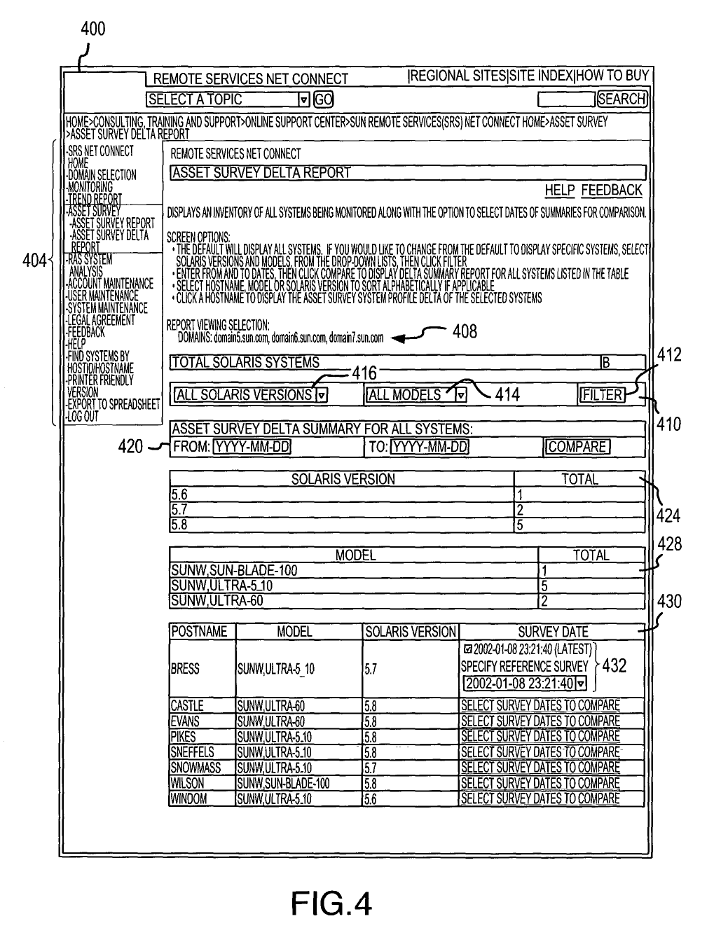

Briefly, the priority queue manager 232 is responsible for maintaining a date-of-arrival ordered list of commands and messages from upstream and downstream relays. The command processor 234 coordinates overall operations of the forwarding relay 220 by interpreting all command (internal) priority messages and also acts as the file cache manager, delayed transmission queue manager, and relay registry agent (as will become more clear from the description of FIGS. 3 and 4). The relay message store mechanism 236 acts to process received message and commands and works in conjunction with the priority queue manager 232 to build messages from data in the message store 242 based on the priority queue library 244 and to control transmission of these built messages. The mechanism 236 functions to guarantee the safety of messages as they are transmitted within the system 200 by creating images of the messages in memory or storage 240 (e.g., on-disk images) and implementing a commit/destroy protocol to manage the on-disk images. In general, a “message” represents a single unit of work that is passed between co-operating processes within the system 200. The priority queue manager 232 functions to generate priority queues (which are stored in library 244). This allows the relay 220 to obtain a date-ordered set of priority queues directly from the mechanism 230.

Generally, the message store 242 stores all messages or data received from upstream and downstream sources while it is being processed for transmittal as a new message. The store 242 may take a number of forms. In one embodiment, the store 242 utilizes a UNIX file system to store message images in a hierarchical structure (such as based on a monitored system or message source identifier and a message priority). The queue library 244 implements a doubly-linked list of elements and allows insertion to both the head and tail of the list with searching being done sequentially from the head of the queue to the tail (further explanation of the “store” function of the forwarding relay 220 is provided with reference to FIGS. 3 and 4). Messages are typically not stored in the queue library but instead message descriptors are used to indicate the presence of messages in the message store 242. The queue manager 232 may create a number of queues in the library 244 such as a queue for each priority level and extra queues for held messages which are stored awaiting proper registration of receiving relays and the like. A garbage collector 248 is provided to maintain the condition of the reliable message store 242, which involves removing messages, or moving messages into an archival area (not shown) with the archiver 246 based on expiry policy of the relay 220 or system 200.

In some embodiments, the forwarding relay 220 with the store and forward mechanism 230 functions to send information based upon the priority assigned (e.g., by the transmitting device such as the monitored system 260 or service provider system 284) to the message. Priorities can be assigned or adjusted based on the system of origination, the function or classification of the message, and other criteria. For example, system internal messages may be assigned the highest priority and sent immediately (e.g., never delayed or within a set time period, such as 5 minutes of posting). Alerts may be set to have the next highest priority relative to the internal messages and sent immediately or within a set time period (barring network and Internet latencies) such as 5 minutes. Nominal trend data is typically smaller in volume and given the next highest priority level. High-volume collected data such as configuration data is given lowest priority. Of course, the particular priorities assigned for messages within the system 200 may be varied to practice the prioritization features of the present invention.

According to an important aspect of the invention, the system 200 is adapted for determining and reporting changes in assets of the, monitored system 260 between two comparison points (e.g., two user-selected dates and/or times, two user-selected surveys, and the like). Assets of a computer system and/or network may include a wide range of hardware and software components and may be varied significantly to practice the present invention. For example, but not as a limitation, the system 200 may be configured to report or display (such as at user interface 265) fundamental changes of the monitored system 260 including a CPU delta, a disk delta, a file system delta, a system packages delta summary, a system patches delta detail, and a network delta. The CPU delta reports or displays CPU change information such as changes in the CPU numbers, types, board numbers, frequencies, sizes of caches, and other CPU information. The disk delta reports or displays hard disk change information such as changes in capacity, device paths, disk models, serial numbers, and revisions. The file system delta reports or displays file system change information such as the changes in the device path(s), mount directories, file system type, total blocks, block size, fragment size, total inodes, and other file system information. The system packages delta summary reports or displays system package change information pertaining to all system packages based on provider, level of installation, and other reporting criteria. The system patches detail reports or displays system patch change information such as patch numbers, installed and current patch revisions with information on the currently installed patches, and other patch characteristics. The network delta reports or displays changes in network interfaces, network operations, and the like.

The monitored system 260 typically includes components to be monitored and surveyed such as one or more CPUs 270 running one or more packages with a plurality of patches, memory 272 having file systems 274 (such as storage area networks (SANs), file server systems, and the like) and disk systems 276, and a network interface 278 linked to a customer or public network 280 (such as a WAN, LAN, or other communication network). A user interface 265 is included to allow a client user to communicate with the service provider system 284 (and specifically with the asset survey mechanism 291 as discussed with reference to FIGS. 3-5) and to allow viewing of asset survey information and asset survey delta reports of the monitored system 260 (e.g., viewing of asset survey data collected at the monitored system 260, processed by the service provider system 284, and transmitted back via the forwarding relay 220 to the monitored system 260). The user interface 265 typically includes a display 266 (such as a monitor) and one or more web browsers 267 to allow viewing of screens of collected and processed data including asset survey delta reports and monitoring information including events, alarms, status, trends, and other information useful for monitoring and evaluating operation of the monitored system 260. The web browsers 267 provide the access point for users of the user interface 265.

Data providers 268 are included to perform asset surveys and collect operating and other data from the system 260 and a data provider manager 264 is provided to control the data providers 268 and to transmit messages to the forwarding relay 220 including assigning a priority to each message. Preferably, the data providers 268 and data provider manager 264 and the relays 220, 218 consume minimal resources on the customer system 210. In one embodiment, the CPU utilization on the monitored system 260 is less than about 0.01 percent of the total CPU utilization and the CPU utilization on the relay system is less than about 1 percent of the total CPU utilization. The data providers 268 typically collect data for a number of monitoring variables such as run queue and utilization for the CPU 270, utilization of memory 272 including information for the file systems 274 and disks 276, and collision, network errors, and deferred packets for the network interface 278. The data providers 268 typically collect configuration data and other asset survey data (i.e., all data necessary to create the asset survey delta reports discussed above). The data providers 268 operate on a scheduled basis such as collecting trend data (e.g., monitoring variable information) every 10 minutes and only performing asset survey once a week or some relatively longer period of time. In some cases, the client user via the user interface 265 or a service provider system 284 operator may adjust asset survey performance periods and/or initiate asset surveys (i.e., operation of the data providers 260 useful for collection of asset data). The data provider manager 264 functions to coordinate collection of data by the data providers 268 and to broker the transmission of data with the relay 220.

The service provider system 284 is linked to the Internet 282 via the firewall 286 for communicating messages with the customer relay 218. The service provider system 284 includes receivers 288 which are responsible for accepting data transmissions from the customer system 210 and brokering the data to the appropriate data loaders 294. Received messages or jobs are queued in job queue 292 and the job queue 292 holds the complete record of the data gathered by a provider 268 until it is processed by the data loaders 294. The job scheduler 290 is responsible for determining which jobs are run and in which order and enables loaders 294 to properly process incoming data. The data loaders 294 function to accept data from the receivers 288 and process the data into final format which is stored in memory 296 as monitored data 297. The data loaders 294 are generally synchronized with the data providers 268 with, in some embodiments, a particular data loader 294 being matched to operate to load data from a particular data provider 268.

According to an important aspect of the invention, the service provider system 284 includes the asset survey mechanism 291 in communication with the data loaders 294, memory 296, and reporting web server 299. The asset survey mechanism 291 acts to identify deltas or changes in the assets of the monitored system 260, to provide a communication interface with the user interface 265, and to report asset changes via delta reports to the user interface 265 (or by other means, such as printed reports) to client users or monitoring personnel.

The asset survey mechanism 291 includes an asset data storage controller 293 for working alone or in combination with the data loaders 294 for managing storage of the asset survey information and, particularly, asset change information in the memory 296 as shown by the asset data 298 database. The operation of the asset survey mechanism 291 is discussed in more detail with reference to FIGS. 3-5. Briefly, however, the system 200 is configured to limit the amount of asset survey data stored in asset data 298 to control the amount of memory 296 required to store information needed for reporting asset change information while still providing a historical picture of the assets of the monitored system 260. In a preferred embodiment, the asset data storage controller 293 operates to process each asset survey for each monitored system 260 (or subsystem) to store only needed asset change information. For example, initial asset survey information is stored in the asset data database 298 in a desired format along with the date (and/or time) for performing the asset survey. When a later asset survey is performed, the asset data storage controller 293 acts to compare the new asset survey information with the stored asset data 298 and changes to all or select portions of the asset data 298 are identified. Then, identified deltas or changes, e.g., the new asset information that was collected, are stored in the asset data 298 along with the survey date (and/or time). In this fashion, only asset survey information that is useful in making asset change determinations is stored to enhance availability of memory 296.

The asset survey change mechanism 295 is provided to work with the reporting web server 299 for communicating with the user interface 265 to request and receive user input (such as reporting parameters or filter values and comparison points) from the client operation. The mechanism 295 then responds to received user input to determine changes in the monitored system assets based on asset data 298 retrieved for each of the comparison points (such as two user-selected asset surveys) and to create and transmit an asset delta report providing the present asset survey information and identified changes. The reporting web server 299 generally functions to combine all the processed data and transmit or report it to the user interface 265. The types of reports may vary but typically include a listing of monitored assets, an asset value or asset data at each comparison point, and a change of status flag or indicator and may be in HTML or other format. While shown as separate devices, the functions of the receivers 288, job scheduler 290, asset survey mechanism 291, data loaders 294, and reporting web server 299 may be provided any number of mechanisms that may be located on one or more servers or other computing devices. Further, the memory 296 may be located in one or more data storage devices within the system 284 or remote but linked to the system 284.

Referring now to FIGS. 3-5, the operation of the systems 100 and 200 are described with particular detail provided for the operation of the service provider system 200 and its asset survey mechanism 291. FIG. 3 illustrates an exemplary asset survey delta reporting process 300 according to the present invention. At 310, asset survey delta reporting begins typically with the establishment of communication links in system 200 (such as the cascaded pipeline described above), registration of various relays and monitored systems 260, and establishment of authorized client personnel for using the user interface 265 to request asset survey reports (such as by the user logging in providing a verified user identification and password). At 320, the data providers 268 are operated to perform data collection for the assets. As discussed previously, changes in assets are determined over a time period, i.e., between two comparison points, and this requires that two asset surveys be performed by the data providers 268 (alternatively, a “no change” determination can be made by the mechanism 291 and reported if there is only one set of asset survey data in memory 296). Selective data storage is performed at 320 by the asset data storage controller 293 by comparing newly collected asset survey data with previously stored asset data 298 to determine changed asset values that are then stored as asset data 298. Typically, the asset data 298 includes asset data from an initial asset survey and then later collected asset survey data that has changed since the initial survey and since intervening surveys. Note, all identified changes (changes between the most recent survey and the arriving asset survey data) are preferably stored to allow the asset survey change mechanism 295 to determine changes between any two survey dates (i.e., comparison points).

At 330, the process 300 continues with establishing an interactive communication link with the client user. This may be achieved in a number of acceptable ways and in one embodiment, involves the client user connecting, such as by logging in, to the service provider system 284. The service provider system 284, such as with the reporting web server 299 and the asset survey mechanism 291, generates one or more web pages or screens that are transmitted to the monitored system 260 and displayed via the web browsers 267 on the display 266. An example screenshot of such a web interface 400 is shown in FIG. 4 and often this interface or screen 400 is displayed when the user makes a selection from the drop-down list 404 indicating their desire to view or receive asset survey delta reports. The main asset delta report screen 400 provides a variety of information retrieved from the memory 296 based on the user's login information (which indicates the monitored systems for which the user has access to view or monitor and/or control). As shown, the main screen 400 includes report viewing selections at 408 indicating the domains or networks that are included in the monitored systems 260 followed by the number of systems within these domains or networks. The tables 424, 428, and 430 show the operating systems and versions used in the monitored systems and the models of servers and/or other hardware assets as well as the host name or identification of each monitored system.

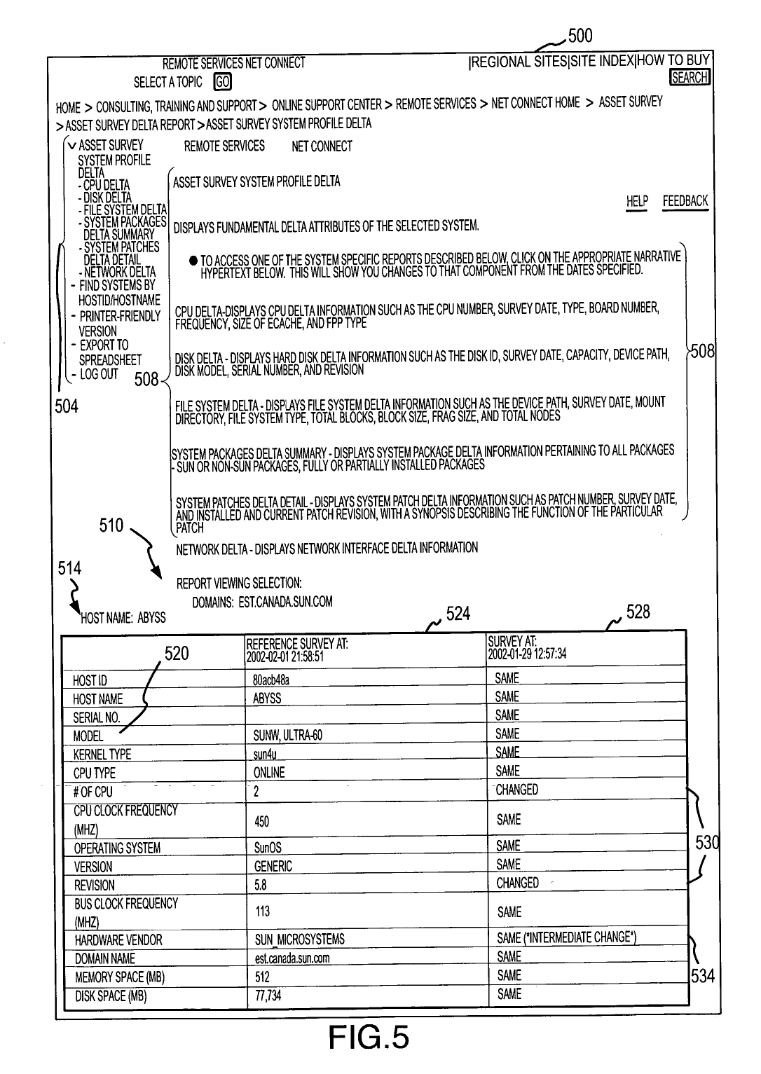

According to an important aspect of the invention, at 340, the process 300 continues with the receipt of viewing parameters and/or filter variables from the client user. The asset survey mechanism 291 is preferably configured to allow a client user to request asset change information on selected portions of the overall monitored system or systems 260. For example, the user may want to quickly determine if an effort to update patches within a particular system has been completed, and the mechanism 291 at step 340 allows the user to provide the system to perform the asset survey data comparison and for which assets (in this example, patches). To this end, the main screen 400 includes a box 410 for a user to enter filter variables. As shown, a drop-down list is provided for entering filter variables 414 such as component models and for entering viewing variables 416 such as which operating systems and the filter button 412 is selected to apply the filter. The user may provide viewing parameters (which may also be labeled or thought of as additional filter variables) by selecting a system to obtain a report for (such as by selecting the system's host name in the table 430) and then by selecting a particular asset for further reporting as further described with reference to FIG. 5).

At 350, the process 300 continues with requesting and receiving at least two comparison points for completing an asset change or delta determination and report. In some embodiments, the user is able to provide a single reference point and then two or more comparison points and the mechanism 291 acts to make asset change determinations and reports for each of the comparison points with the reference point. As shown in FIG. 4, the asset survey delta input screen 400 includes an input box 420 with data entry boxes for entering comparison points, i.e., dates, and for initiating the comparison by selecting a “compare” button. Alternatively, the user may use the table 430 to select survey dates to compare by requesting that all available survey dates or times (i.e., when surveys were completed and data stored in memory 296) be displayed and then selecting two surveys for comparison points.

At 360, the asset survey change mechanism 295 retrieves for the two comparison points the asset survey data 298. If a date is given as a comparison point, the asset survey data 298 for the survey taken most recently prior to that date is retrieved. Typically, the asset data retrieved is reduced by the viewing parameters and filter variables previously entered by the client user at 340 or alternatively, all asset survey data for the comparison points is retrieved and the processed data is filtered or otherwise reduced prior to creating a report based on the client input of step 340.

At 370, the asset survey change mechanism 295 acts to compare the retrieved asset survey data to determine asset changes in the requested or filtered assets of the monitored system or systems 260. Comparison results are then compiled into or used for creating an asset delta report based on the user-selected viewing parameters and filter variables. The asset delta report is then transmitted to the user interface 265 (or otherwise provided to the requester) for viewing on the display 266.

FIG. 5 illustrates one exemplary delta report 500, e.g., an asset survey system profile delta report, prepared for a single monitored system 260. Again, the report screen 500 provides a list of links 504 for a user to quickly determine which delta report is being viewed and to select or drill down to more detailed reports. The contents of the selectable detailed delta reports are shown in screen area 508 and include CPU delta reports, disk delta reports, file system delta reports, system packages delta summary reports, system patches delta detail reports, and network delta reports. These more specific delta reports (not shown) can be viewed or obtained by selecting a hyperlink or by another useful linking method from screen 500. The specific domain or network being viewed is shown at 510 and the specific system within such domain or network is detailed at 514 by host name. The table 520 provides a listing of each of the assets that was available in asset data 298 (or was available and not filtered out by viewing parameters and filter variables input by the user) and other system information, such as host identification, host name, and the like.

As shown, two reference points were compared by the mechanism 291 for user-input comparison points (i.e., two surveys or survey dates). In the illustrated embodiment, column 524 provides the existing asset survey data in memory 296 for the later of the two comparison points and column 528 of comparison table 520 indicates whether the asset data (and the underlying asset itself) has been changed since earlier comparison point. The changes may be indicated in numerous fashions such as with text (e.g., phrases such as “same”, “no change”, “changed”, “modified”, and the like) and/or other visual cues such as a colored background behind the text or by itself or flashing text or background. As illustrated, identified changes are shown at 530 with the text “changed” provided in the column 528. In some embodiments of the invention, the asset survey change mechanism 295 further acts to determine whether asset changes occurred at intermediate points between the two comparison points (that now have been changed back), which is useful for narrowing in on when changes were made to an asset and for diagnosing problems to a particular asset that may otherwise be hidden if no changes were indicated. Such an intermediate asset change may be indicated in a number of ways including the method illustrated of flagging such a change with the text “(*Intermediate Change*).” The mechanism 291 then allows a user to obtain more detail on the change by selecting an asset survey report for the earlier comparison point or by selecting the particular asset for which the change is indicated, which results in a reporting of the specific change or of the prior asset survey data for that asset at the earlier comparison point.

Although the invention has been described and illustrated with a certain degree of particularity, it is understood that the present disclosure has been made only by way of example and that numerous changes in the combination and arrangement of parts can be resorted to by those skilled in the art without departing from the spirit and scope of the invention, as hereinafter claimed. For example, FIG. 5 illustrates comparison between two points with the delta engine of the invention but the delta engine is useful for multiple comparison points or change points. The reports then may display the results of such multiple comparison point analysis and display change histories.

We claim:

1. A method for tracking and reporting changes to monitored computer and network assets within a system monitoring system, comprising:
establishing a communications link over a communications network with a client monitoring node;
receiving from the client monitoring node a first comparison point and a second comparison point;
retrieving from memory storing asset data a first set of the asset data corresponding to the first comparison point and a second set of the asset data corresponding to the second comparison point;
comparing the second set of asset data to the first set of asset data to identify asset deltas occurring between the first and second comparison points; and
transmitting an asset delta report to the client monitoring node including the identified asset deltas.

2. The method of claim 1, wherein the first and second comparison points are user-selected calendar dates.

3. The method of claim 1, further including transmitting to the client monitoring node a listing of asset survey dates for which the asset data was collected and stored in the memory and wherein the first and second comparison points are user-selected ones of the asset survey dates in the listing.

4. The method of claim 1, wherein the asset delta report includes an asset listing for the first and second comparison points and a status indicator for each asset in the asset listing indicating the identified asset deltas and indicating no-change ones of the assets.

5. The method of claim 4, wherein the status indicator further indicates interim changes between the first and second comparison points.

6. The method of claim 5, further including receiving from the client monitoring node viewing parameters including a user-selected monitored system and wherein the retrieving is performed to retrieve the first and second sets of asset data corresponding to the monitored system.

7. The method of claim 1, further including receiving from the client monitoring node filtering variables including a set of system assets for use in the comparing and wherein the comparing is performed for the set of system assets.

8. An asset delta reporting system, comprising:
a data storage device for storing asset data for a monitored computer system;
a data receiver for interfacing with a communications network and receiving an initial set of asset data for assets in the monitored computer system and a later-collected set of asset data for the assets in the monitored computer system gathered after the initial set; and
an asset data storage controller configured to store the initial set of asset data in the data storage device, to compare the later-collected set of asset data to the stored initial set of asset data to identify asset deltas, and to store in the data storage device portions of the later-collected set of asset data corresponding to the identified asset deltas.

9. The system of claim 8, wherein the asset data storage controller further operates to compare additional ones of the later-collected sets of the asset data to a previously stored set of the asset data to identify additional ones of the asset deltas and to store portions of the additional later-collected sets corresponding to the additional asset deltas in the data storage device.

10. The system of claim 9, further including a user interface linked to the communications network for inputting and transmitting user-selected first and second comparison points over the communications network and including an asset survey change mechanism processing the user-selected first and second comparison points and in response, comparing the stored portions of the asset data corresponding to the first and second comparison points to identify changes in the asset data.

11. The system of claim 10, further including a reporting web server for generating an asset delta report including an asset status for each asset in the asset data and for transmitting the asset delta report to the user interface, wherein the asset status indicates the identified changes in the asset data.

12. The system of claim 11, wherein the delta asset report includes a set of the asset data at the first and second comparison point.

13. The system of claim 10, wherein the user interface is further configured for inputting filter variables indicating a set of the assets in the monitored computer system for use in comparison operations by the asset survey change mechanism.

14. A computerized method of reporting changes to system and network assets in a client computer environment, comprising:
gathering asset data for assets in monitored systems in the client computer environment at an initial survey time and at a plurality of later asset survey times;
storing at least a portion of the gathered asset data in memory;
receiving user input comprising a first and a second comparison time and change reporting information; and
based on the change reporting information, comparing the stored asset data corresponding to the first and second comparison times to identify asset deltas and reporting the identified asset deltas.

15. The method of claim 14, wherein the change reporting information comprises a subset of the monitored systems.

16. The method of claim 14, wherein the change reporting information comprises a subset of the assets.

17. The method of claim 14, wherein the storing includes determining between each consecutive pair of later asset survey times asset deltas for each of the assets and wherein the stored portion of the gathered asset data for each second one of the consecutive pair of later asset survey times comprises the gathered asset data for the assets corresponding to the asset deltas.

18. The method of claim 14, wherein the reporting includes flagging each of the assets corresponding to the identified asset deltas.

19. The method of claim 14, wherein the comparing further includes comparing the stored asset data corresponding to intermediary ones of the later asset survey times between the first and second comparison times to identify intermediary asset deltas and wherein the reporting further includes flagging the assets corresponding to the identified intermediary asset deltas.

20. The method of claim 14, wherein the comparing comprises first determining the corresponding stored asset data based on the first and second comparison times by identifying a most recent one of the initial and later asset survey times relative to the first and second comparison times.
